(19) United States
(12) Patent Application Publication
(10) Pub. No.: US 2009/0116785 A1
(43) Pub. Date: May 7, 2009

(54) Device for delaying an optical signal

(75) Inventors: Michael Charles Parker, Essex (GB); Stuart Douglas Walker, Essex (GB)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/725,553

(22) Filed: Mar. 20, 2007

(30) Foreign Application Priority Data
Mar. 20, 2006 (GB) 0605598.2

(51) Int. Cl. G02B 6/28

(52) U.S. Cl. 385/24

(57) ABSTRACT

An apparatus and method for providing a delay to an optical signal including a Latin router having a plurality of input ports, including at least one signal-input port, and a plurality of output ports, including at least one signal-output port, and a plurality of optical waveguides, each connecting one of the input ports to one of the output ports that is not a signal-output port, in which the plurality of waveguides are connected between the input ports and the output ports in an arrangement such that a first signal entering the device and mapped to any one of the output ports experiences a delay that is different from a delay that is experienced by a second signal entering the device and mapped to a different one of the output ports.

### CROSS-REFERENCE TO RELATED APPLICATIONS

The present application is based on and claims priority from Great Britain Application Number 0605598.2, filed Mar. 20, 2006, the disclosure of which is hereby incorporated by reference herein in its entirety.

### BACKGROUND OF THE INVENTION

1. Field of the Invention

This invention relates to devices for delaying optical signals, in particular devices for providing selectable delays or optical memories.

2. Description of the Related Art

Optical packet switching is emerging as an important technology for supporting next-generation Internet-Protocol (IP)-based photonic networks. In addition, optical-based signal processing, access network edge switching, and optical-interconnects within computing systems are becoming key technologies for future high bit-rate data transmission and manipulation. In the context of optical buffering and memory (e.g. fine synchronization in optical Time-division-multiplexed (TDM) systems, multiplexing/de-multiplexing at the edge of the switch fabric, or timeslot interchange) a selectable optical-delay device is of great importance for efficient operation. There have been various suggestions for optical delay-lines based on inter alia photonic crystals, ring resonators, electromagnetically-induced transparency (EIT), and coupled cavity optical waveguides. However, each of those technologies involves a compromise between complexity, tunability, available bandwidth, speed and size.

Vidal, B. et al. have proposed (in “Optical Delay Line Based on Arrayed Waveguide Gratings' Spectral Periodicity and Dispersive Media for Antenna Beamforming Applications”, IEEE J. Sal. Topics Quantum Elec., Vol. 8, No. 6, pp 1202-1210) using an arrayed-waveguide grating (AWG) for selectable time delays for a signal.

An AWG typically comprises (see the central box of FIG. 1) a plurality of input ports (1 . . . N) on an input side of a first free-propagation region 14 and a plurality of output ports (I . . . N) on an output side of a second free-propagation region 15 (the free-propagation regions are solid regions; for example, they may be made of silica). Within the AWG, an array of waveguides interconnects the first free-propagation region 14 and the second free-propagation region 15. The optical path lengths of adjacent waveguides of the array usually increase linearly across the waveguide. Different spectral components of signals input to the AWG on an input port generally emerge from the AWG at different output ports.

An “active” AWG is an AWG that may be tuned, so that the mapping of different wavelengths between different input and output ports can be changed. Tuning is typically achieved by changing a voltage applied to an active trapezoidal region 12 arranged to provide a voltage-dependent linear phase profile in the Fourier plane of the AWG. The active region is provided in one of a number of ways, for example as a layer of hydrogenated amorphous silicon (α-Si:H) for an AWG based on silicon technology, or for example a thermo-optic region for an AWG based on silica, or for example electrodes in an AWG based on indium phosphide or lithium niobate technology.

FIG. 1 shows a schematic representation of the Vidal, B. at al. device. Active AWG 10 is an 8×8 device (i.e., it has 8 input ports 20 and 8 output ports 30). The individual ports are labelled 1-8 on each side for convenience of description. Port 1 on the input side is a signal-input port 25 and Port 1 on the output side is a signal-output port 35. Ports 2-8 on each side are connected by a plurality of external waveguides 40, with each waveguide connecting one output port to one input port, with output port 2 connected to input port 8, output port 3 connected to input port 7, and so on. The waveguides are of increasing length (the waveguide connecting output port 2 and input port 8 is the shortest, that connecting output port 8 and input port 2 the longest), so that they provide increasingly long time delays to signals routed along them.

Such a scheme does not scale well with increasing number N of selectable times delays (where N=8 in the FIG. 1 example), since the overall summed length of waveguide track increases as N (N−1)/2, increasing polynomially with N, and so is expensive in terms of real estate (i.e. the chip area required for the device).

It is desirable to be able to provide a device for providing a delay to an optical signal while still mitigating or eliminating at least some of the above-mentioned disadvantages.

### SUMMARY OF THE INVENTION

Various embodiments of the invention provides a device for providing a delay to an optical signal, comprising:

(a) a Latin router comprising a plurality of input ports, including at least one signal-input port, and a plurality of output ports, including at least one signal-output port, wherein input ports are mapped within the router output ports according to a Latin-routing mapping matrix; and

(b) a plurality of optical waveguides, each connecting one of the input ports to one of the output ports that is not a signal-output port, wherein at least two of the plurality of waveguides are of the same length and wherein the plurality of waveguides are connected between the input ports and the output ports in an arrangement such that a first signal entering the device and mapped to any one of the output ports experiences a delay that is different from a delay that is experienced by a second signal entering the device and mapped to a different one of the output ports.

The input ports are “mapped” to the output ports in the sense that a signal entering the router at an input port will propagate directly to the output port to which that input port is mapped (without passing along a waveguide or otherwise leaving the router).

A Latin Router is an N×N router whose mapping matrix is a Latin Square. The mapping matrix shows how input ports 1 to N (the rows or columns of the square) and channel numbers 1 to N within a given signal (the columns or rows of the square) map to a given output port 1 to N. A Latin Square is a N×N grid of numbers in which no number appears more than once in a row or column. Latin routing is described by Barry & Humblet at pp. 891-899, J. Lightwave Tech., Vol. 11, No. 5/6, May/June 1993.

Various embodiments of the invention use a Latin router to provide delays of different duration. If the waveguides are of an equal length (and neglecting any small differences in path length within the router), the delay experienced by a signal within the router will be proportional to the number of times it circulates around the device (the router and the connected waveguides). The signal enters at an input port, is routed to an output port, and is guided along a waveguide to another input port. The process is repeated until the signal reaches a signal-output port, from whence it is outputted from the device. The waveguides are arranged so that a signal routed to a given output port follows a different route around the device, and experiences a different total delay, from at least one other signal routed to any of the other output ports.

It may be that at least half of the external waveguides are of the same length. It may be that all of the external waveguides are of the same length. It may be that a signal entering the device and mapped to any one of the output ports experiences a delay that is different from the delay experienced by a signal mapped to any other one of the output ports. Thus, all signals mapped to different output ports may experience different delays.

The plurality of waveguides may be connected to the input and output ports to form an arrangement of connections that provides a selected desired delay. The plurality of waveguides may be connected to different ones of the input and output ports to form an arrangement of connections that provides a selected, desired set of delays. The selected set of delays may be a set of delays for a plurality of multiplexed channels that are comprised in the signal.

It may be that the router has N input ports and N output ports and a signal first routed (i.e. mapped from an input port) to an nth output port (where n is an integer between 1 and N, inclusive) is delayed by a delay of (n−1) times a delay τ, for all n. The N output ports may be labeled sequentially from 1 to N (so that adjacent output ports have consecutive labels, e.g 1, 2, 3, 4, 5, 6, 7, 8). The N output ports may be labeled in a cyclic permutated sequence from 1 to N that includes a cyclic (or modulo) discontinuity (e.g. 4, 5, 6, 7, 8, 1, 2, 3). If a multiplexed signal is input to a port of the device, each channel of the signal thus experiences a delay determined by its wavelength, as successive wavelength channels are output at successive output ports.

The device may further comprise a tuning means that acts to alter the (internal, Latin-routing) mapping between the input ports and the output ports, preferably in a cyclic manner and preferably according to the Latin routing of the device (so that output port n is associated with a row or column in the Latin Square that is a row or column that was previously associated with output port n+p (modulo N), where 1<=p<=N). Thus, at least one of the input ports may map to a first output port at a first setting of the tuning means and to a different output port at a second setting of the tuning means.

It may be that only one input port is a signal-input port; that is, a port at which a signal may be input. All input ports other than the signal-input port may be connected to output ports by the waveguides.

There may be a plurality of signal-input ports. Thus, different signals (or different channels of a multiplexed signal) may be input on different signal input ports. The waveguides may connect output ports to at least some of the signal-input ports. The waveguides may be connected to the signal input ports at optical circulators.

For some arrangements of waveguides between input and output ports, signals may become trapped within the device, never being routed to a signal-output port for outputting the signal from the device. A switch may be provided to allow the trapped signal to escape from the device. For example, at least one of the waveguides may be connected to a nonlinear optical loop mirror. Alternatively, for example, the internal routing of the router may be changed by tuning so that the trapped signal is routed to a signal-output port.

The Latin router may be, for example, an arrayed waveguide grating, a Mach-Zehnder interferometer, or a Micro-Electro-Mechanical System optical router.

A second aspect of the invention provides a method of delaying an optical signal, comprising:

(a) inputting an optical signal into a Latin router comprising a plurality of input ports, including at least one signal-input port and a plurality of output ports including at least one signal-output port;

(b) delaying the signal by:
(i) routing the signal within the router to an output port, and
(ii) guiding the signal from said output port to one of the input ports along one of a plurality of waveguides, at least two of which are of equal length, each of the plurality of waveguides being connected to one of the output ports and joining said output port to one of the input ports; and
(c) outputting the signal from the router.

The method may further comprise tuning a tuning means associated with the router, to change the (internal) routing of the signal from the input port to the output port.

The method may further comprise storing the signal within the router and waveguides.

The signal may comprise a plurality of multiplexed channels, and the method may comprise demultiplexing the channels, routing the demultiplexed channels to a plurality of the output ports, guiding the channel or channels routed to each of said output ports to a respective one of the input ports along a respective one of a plurality of waveguides, at least two of which are of equal length, and outputting the channel from the router. The channels may be demultiplexed prior to entering the input port of the router. The demultiplexed channels may then be input into the router on different input ports.

A third aspect of the invention provides a method of simulating a device according to the first aspect of the invention, comprising:

(a) selecting a desired delay;

(b) simulating inputting an optical signal into the Latin router;

(c) simulating delaying the signal by:
(i) routing the signal within the router to an output port;
(ii) guiding the signal from said output port to one of the input ports along one of the plurality of waveguides, said plurality of waveguides being arranged in a first arrangement;
(iii) repeating steps (i) and (ii) until the signal arrives at the signal-output port;
(iv) noting the total delay accumulated in steps (i) to (iii);

(d) simulating altering the delay experienced by the signal by altering at least one waveguide connection to provide a different arrangement of the waveguides and by repeating step (c); and

(e) repeating step (d) to identify an arrangement of connections that provides the desired delay.

Step (c) may further comprise simulating altering the internal mapping of the router, so that the signal is routed to a different output port, and repeating steps (c)(i) to (iv).

The method may include repeating steps (b) to (d) until all permutations of waveguide arrangement and internal mapping have been simulated. The method may thus include altering the waveguide arrangement and the internal mapping of the router (for each waveguide arrangement) until all permutations of waveguide arrangement and internal mapping have been simulated.

The method may further comprise selecting a set of desired delays associated with each of the input ports, simulating input of a signal on each of the input ports and simulating connecting the plurality of waveguides to different ones of the input and output ports to identify an arrangement of connections that provides the desired set of delays.

The selected set of delays may be a set of delays for a plurality of multiplexed channels comprised in the signal, and the method may comprise simulating passage of the channels through the device for different arrangements of connections and identifying an arrangement of connections that provides the desired set of delays.

For some combinations of external waveguide arrangement and internal mapping it is expected that the signal will be trapped indefinitely within the device. In that case, the method will include the step of terminating simulation of that combination once it has become apparent that the signal is trapped (for example, if the delay exceeds (N−1)τ).

It may be that no delay within the set is equal to any other delay within the set of delays. It may be that the router has N input ports and N output ports and a signal input to the n^{th} output port (where n is an integer between 1 and N, inclusive) is delayed by a delay of (n−1) times a delay τ, for all n (see above).

A fourth aspect of the invention provides a method of delaying an optical signal, comprising constructing a device according to the first aspect of the invention according to an arrangement identified by a method according to the third aspect of the invention.

A fifth aspect of the invention provides a device according to the first aspect of the invention, wherein the plurality of waveguides are connected between the input ports and the output ports in an arrangement identified by a method according to the third aspect of the invention.

It will be appreciated that features of the invention described in relation to any aspect of the invention are equally applicable to any other aspect of the invention.

### BRIEF DESCRIPTION OF THE DRAWINGS

Certain illustrative embodiments of the invention will now be described in detail, by way of example only, with reference to the accompanying drawings, in which:

FIG. 1 is an example of a known device for providing selectable time delays, utilizing an AWG;

FIG. 2 is an example of a device according to an embodiment of the invention;

FIG. 3 is an illustration of cyclic Latin-routing configurations for the device of FIG. 2;

FIG. 4 shows another example of a device according to an embodiment of the invention;

FIG. 5 shows two concatenated devices of the kind shown in FIG. 2;

FIG. 6 is a flow chart illustrating an example of a simulation according to an embodiment of the invention;

FIG. 7 is an example of a device providing perfect dispersion according to an embodiment of the invention;

FIG. 8 is another example of a device according to an embodiment of the invention, being used to delay four WDM channels;

FIG. 9 shows the example of FIG. 8, being used to delay twelve WDM channels;

FIG. 10 shows two concatenated devices according to embodiments of the invention, being used to delay twelve WDM channels.

### DETAILED DESCRIPTION OF THE PREFERRED EMBODIMENTS

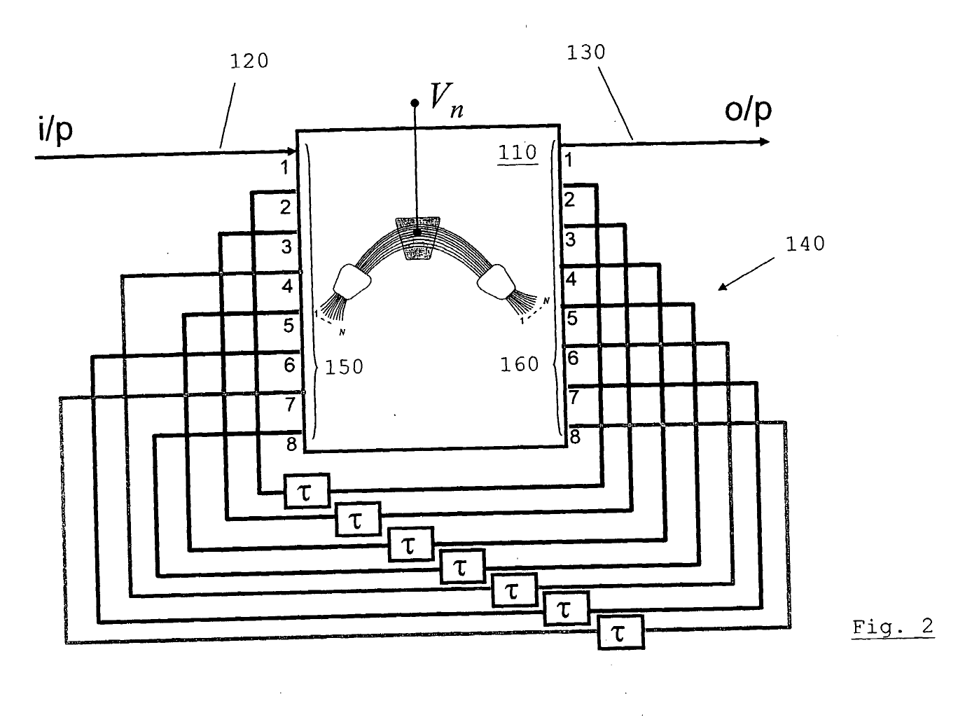

The reconfigurable optical delay architecture of the device of FIG. 2 is based upon a tunable AWG 110 within a configuration of waveguides 140. Waveguides 140 connect ports 2 to 8 of input ports 150 to ports 2 to 8 of output ports 160, forming a uniform-length racetrack maze configuration. AWG 110 is tunable using an active trapezoidal region at its center (i.e. at its Fourier plane) and the trapezoidal region acts as a tunable prism, providing a voltage-dependent linear phase profile in the AWG's Fourier plane.

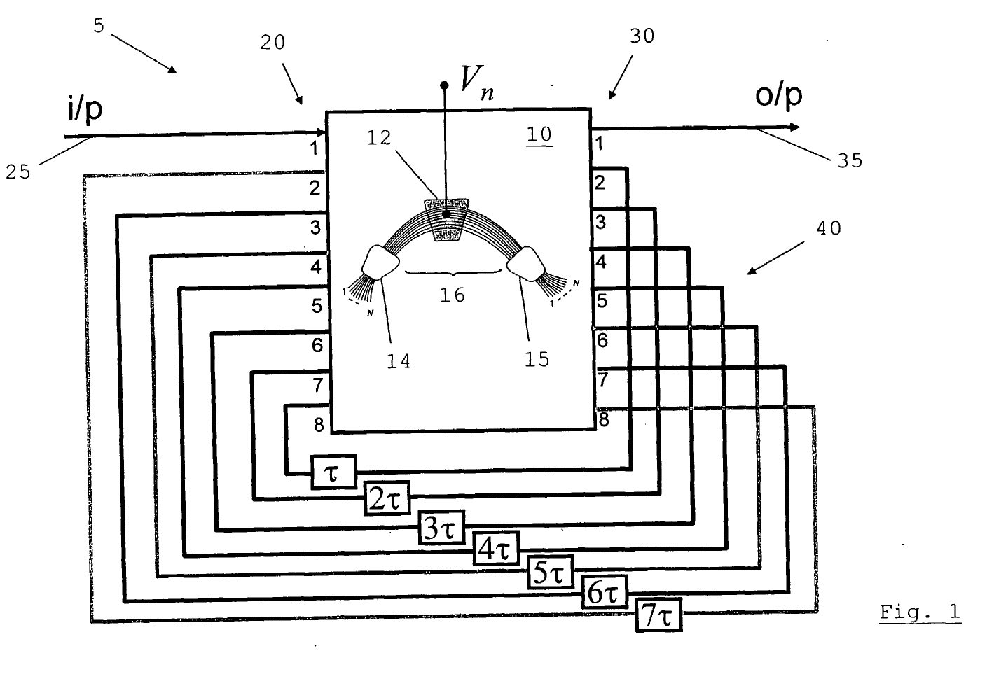

The device of FIG. 2 does not have the port-connection cycle symmetry ordering of the device of FIG. 1. The inherent bidirectional nature of the AWG and the overall architecture allows reflection at the signal-output port 130 to double the allowable delay. The bi-directionality can also be advantageously deployed in add-drop and router buffer applications.

The device takes advantage of the Latin-routing characteristic of AWG 110 to achieve a tunable optical-delay device whose overall waveguide track length simply increases linearly with N (c. f. the N (N−1)/2 of the Vidal, B. et al. device).

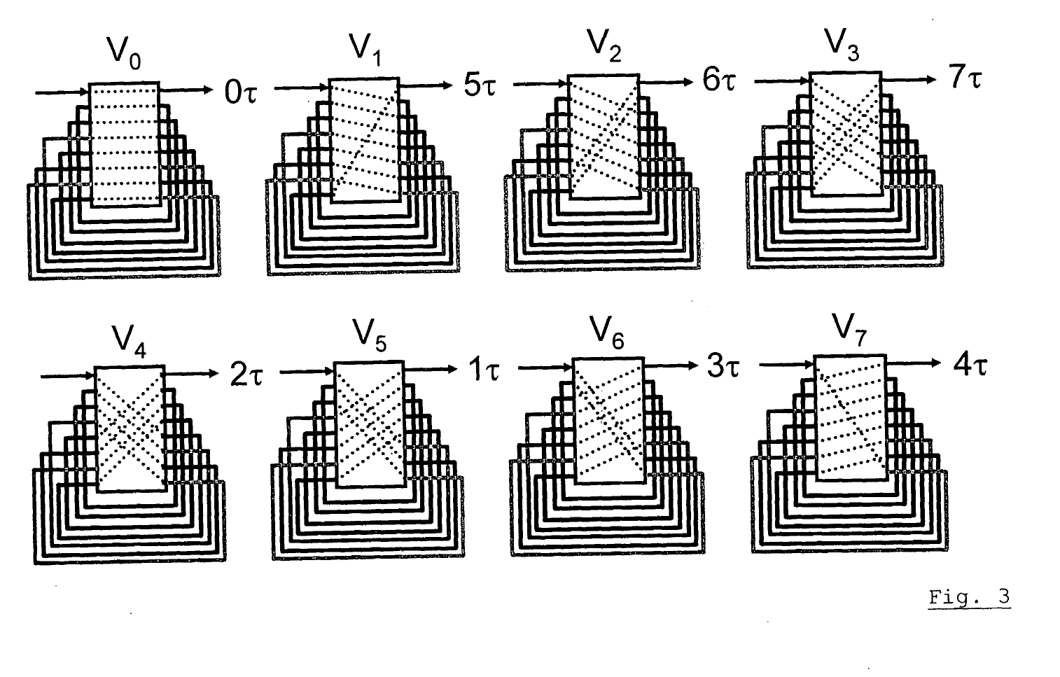

FIG. 3 shows the eight Latin routing configurations for the reconfigurable AWG 110 of FIG. 2.

In FIG. 3, the internal dotted lines for each configuration indicate the variable logical connectivity between the AWG input ports 150 and output ports 160. That connectivity results from the usual diffractive, signal-routing behavior of the AWG 110, tuned using its active region. To reconfigure AWG 110, one of a set of voltages Vₙ (n=0-7) is applied to its trapezoidal active region. The change in voltage results in a change in the mapping of the input signal from signal-input port 120 to the output ports 160 (i.e. the signal is mapped to a different one of output ports 160 according to the voltage Vₙ applied to the trapezoidal region). The change in mapping in turn results in a change in the overall delay experienced by the signal as it circulates around the overall device, from signal-input port 120, via zero, one or more trips through waveguides 140, to signal-output port 130.

The solid lines in FIG. 3 represent the racetrack-maze configuration of the waveguides 140, looping AWG ports 160 at the output plane (except for signal-output port 130) back to the ports 150 at the input plane (except for signal input port 120). That configuration or arrangement of waveguides is fixed, being “hard-wired” into the device.

For a signal entering at signal-input port 120 (input port 1 ), the time-delay associated with each nth configuration is shown in FIG. 3 at signal output port 130 (output port 1). Although in general the time-delays do not increase monotonically with the n, the full range of possible delays between 0 and 7τ is possible.

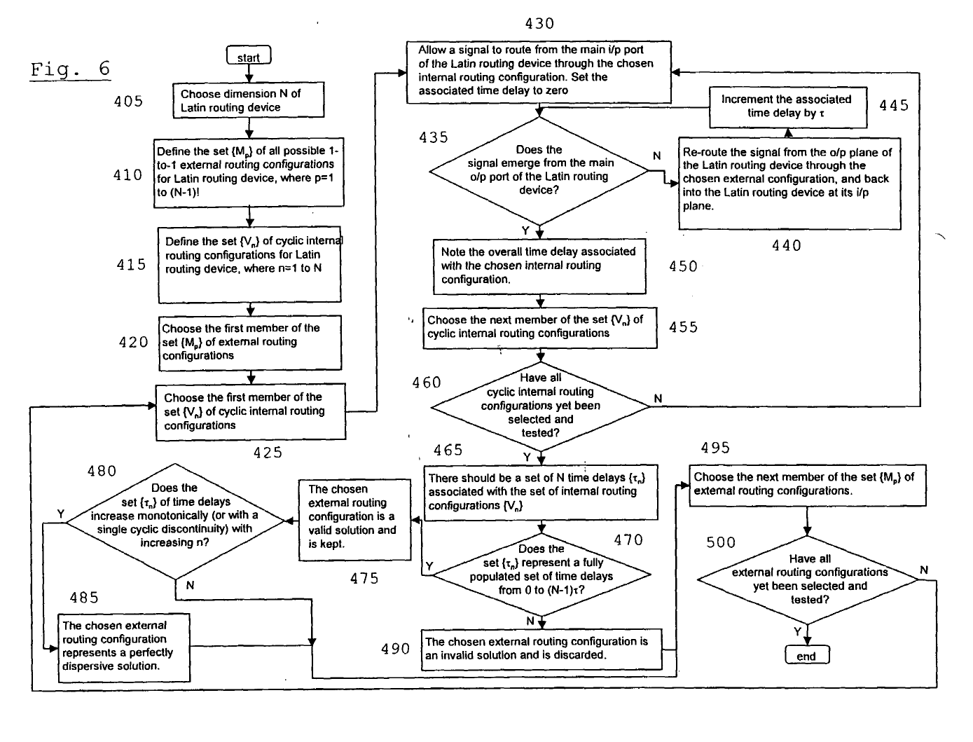

Appropriate configurations for an N×N AWG were found by an exhaustive search using the mathematical software Matlab®. In the example simulation (FIG. 6), the dimension of the routing device to be simulated is chosen (box 405). The sets of all possible internal mappings and external waveguide arrangements are then defined (boxes 410, 415, respectively). A first member of each set is chosen (boxes 420, 425). Propagation of a signal through a device having the chosen internal mappings and external waveguide arrangement is then simulated (boxes 430 to 450). During this process, signal propagation within the router from the signal-input port is simulated (box 430). If the signal propagates immediately to the signal-output port then the overall time delay is noted as zero. Otherwise, the signal passes along one of the waveguides to another input port (box 440) (according to the configuration of the external waveguides), from whence its propagation in the device is again simulated. That process is repeated until the signal eventually reaches the signal-output port. The time delay is then noted as being the number of passages that the signal has made through the waveguides.

When the delay associated with the first internal mapping has been determined (box 450), the next member of the set of internal mappings is chosen (box 455) and the delay associated with that mapping is determined in the same manner. That is repeated until all internal mappings have been tested (box 460). The set of time delays associated with the internal mappings of the chosen external configuration is then checked to see if it includes mappings that have delays conforming to a desired pattern (boxes 470 to 485). In the example of FIG. 6, two patterns are checked for, first, every possible time delay being represented (box 470 and 475) and, second (a sub-set of the first pattern), the set of time delays being suitable for providing “perfect dispersion” (see below) (boxes 480 and 485). Sets matching the first or both of those patterns are noted.

If no set matches the desired pattern, the external waveguide arrangement is discarded (box 490). In that case, or when the checking process (boxes 470 to 485) is complete, a new member of the set of external-waveguide arrangements is chosen (box 495). The whole process (boxes 425 to 485) is then repeated until all external waveguide configurations have been tested (box 500). When that is achieved, all combinations of internal mappings and external arrangements that match the desired pattern will have been noted, together with their associated time delays.

The labeling of the entry and exit ports at the input planes 150 and output planes 160 as shown in FIG. 2 is a canonical disposition. Analysis shows that scrolling the entry port and exit port labeling while keeping the labels laterally symmetric (i.e. keeping like-numbered ports opposite one another) yields the same functionality. Skewed dispositions of the input and output ports simply yield a cyclic permutation of the rows of Table 1.

TABLE 1

| Entry | | | | | | | | |
|---|---|---|---|---|---|---|---|---|
| Port | V0 | V1 | V2 | V3 | V4 | V5 | V6 | V7 |
| 1 | 0 | 5 | 6 | 7 | 2 | 1 | 3 | 4 |
| 2 | 1 | 4 | 3 | 4 | 5 | 5 | 4 | 0 |
| 3 | 1 | 3 | 5 | 2 | 5 | 5 | 0 | 1 |
| 4 | 5 | 1 | 1 | 1 | 5 | 0 | 4 | 2 |
| 5 | 5 | 2 | 2 | 6 | 0 | 5 | 1 | 1 |
| 6 | 5 | 1 | 1 | 0 | 5 | 5 | 2 | 2 |
| 7 | 5 | 1 | 0 | 5 | 5 | 5 | 4 | 3 |
| 8 | 5 | 0 | 4 | 3 | 1 | 1 | 4 | 2 |

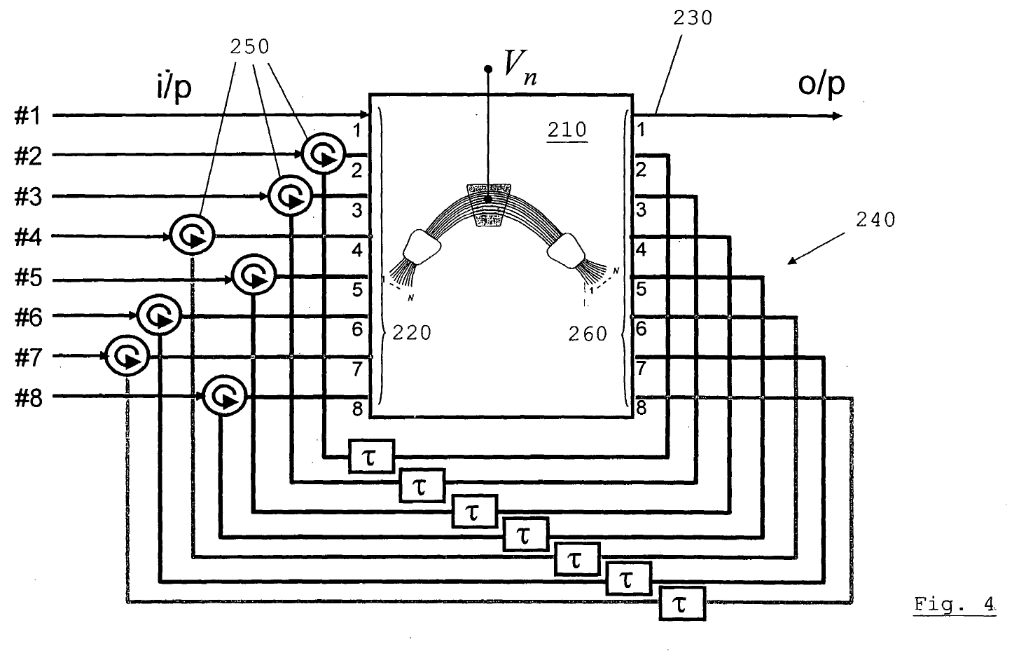

The device of FIG. 4 uses optical circulators 250 to enable input ports 220 to function as signal-input ports as well as receiving waveguides 240. Signals can thus enter at any of the signals-input ports 220 (labeled 1-8) via the port's optical circulator. Signal-input ports 220 are also connected 1-to-1 to output ports 260 (except for signal-output port 230), as in the FIG. 2 example, so the basic racetrack-maze functionality of the device is preserved.

Numbers in bold in Table 1 are the relative time delays provided by the indicated combination of signal-input port 220 (now not necessarily port 1) and control voltage Vn. The table shows that the device can function as an optical memory when a signal is input at particular ones of input ports 220 (FIG. 4). Certain configurations of control voltage Vn and input port 220 have no defined exit and the signal is retained within the AWG router 210 and external waveguides 240 in a labyrinthine confinement. Rather than being output, the signal recirculates in the maze of waveguides 240 with a time-delay (indicated by the number in italics in Table 1) for each loop.

Assuming one packet per racetrack waveguide 240, the number in italics in Table 1 also indicates the number of packets which can be stored in memory for that particular configuration. The quantity of bits per time delay is a design choice, and can be scaled up. Multiple data streams (up to N−1 in number) can be stored in such a configuration, e.g. Table 1 shows that 5×5 packets and 2×1 packet lengths (i.e. 7 streams consisting of 27 packets in total) can be stored within the racetrack-maze for the n=0 configuration.

A non-linear optical loop mirror (not shown) is employed to controllably break the looping of retained signals and allow data to be read from the particular memory store (in an alternative embodiment, the voltage Vn is changed to change the AWG's internal mapping configuration and allow the data to exit at the signal output port 230).

Table 1 also indicates the result of using the AWG 210 in its wavelength-division multiplexing (WDM) role where multiplexed wavelengths are introduced at input port #1. In this case, the AWG routes different signal wavelengths to different output ports 260, according to its Latin routing and its WDM-demultiplexing behavior, with each wavelength seeing a different racetrack-maze waveguide configuration, so that said wavelength is either delayed or stored by the indicated amounts. Varying the control voltage Vn changes the delay times or memory configurations accordingly.

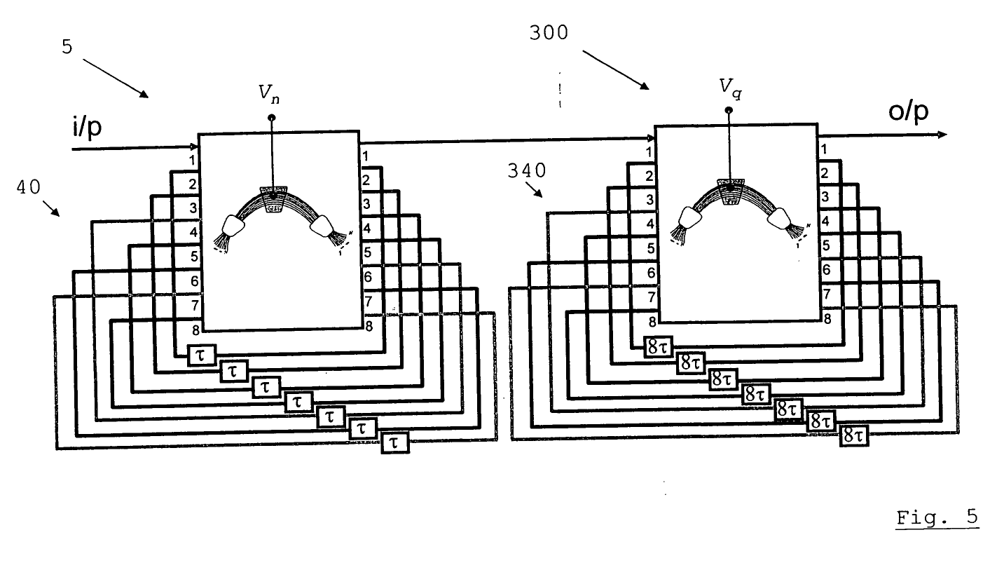

Concatenation of devices such as those of FIGS. 2 or 4 allows increased time-delays, while still exploiting the low real-estate requirements of the design. FIG. 5 shows concatenation of two B×B devices 5, 300. The first device 5 comprises unit-delay waveguides 40, as described above. The second device is identical, save that it comprises waveguides 340 providing eight times (i.e. N times) longer delay for each track. Application of two control voltages, Vn and Vq allows any integer time-delay between 0 and 63τ to be selected, in a compact geometry using only a total of 7×1+7×8=63 unit-length waveguides.

Some external-waveguide configurations connecting the output plane of a Latin routing device to the input plane will yield a “perfectly dispersive” set of optical time delays. That occurs when the time delays associated with the set of internal, Latin-routing mappings increase monotonically as the set of mappings is cycled. Alternatively, although the time delays associated with the set increases monotonically, there may be a single discontinuity (analogous to a 2 pi modulo phase shift) in the set of time delays. Since the Latin routing device may be periodic in nature (e.g. an AWG has a free-spectral range), this single discontinuity is not important, and the device remains perfectly dispersive.

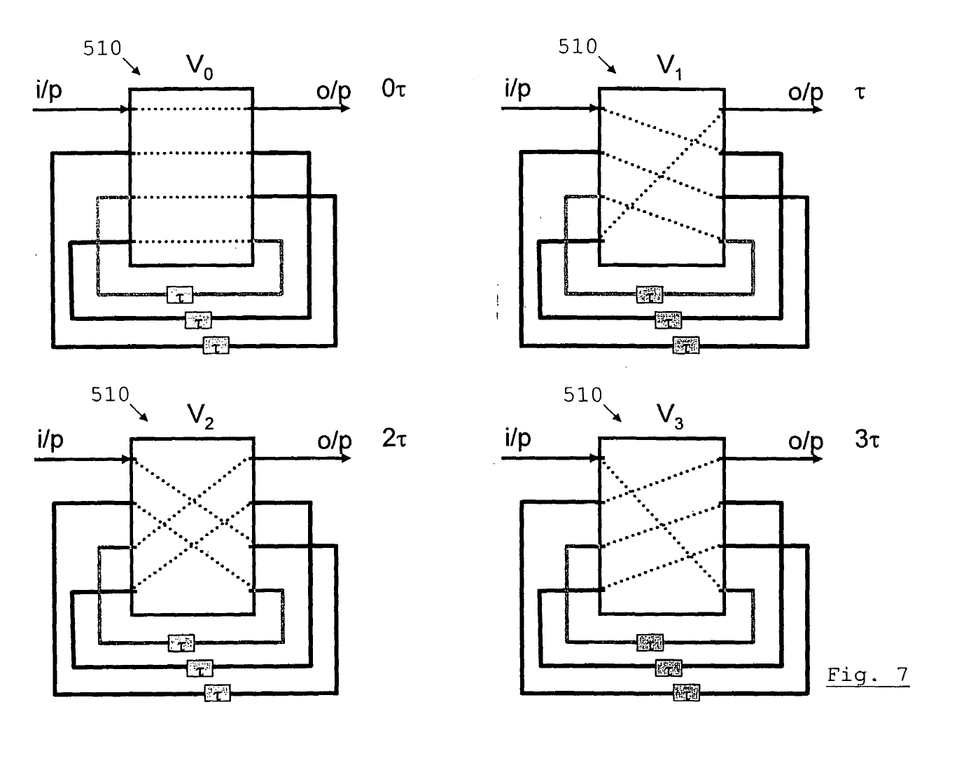

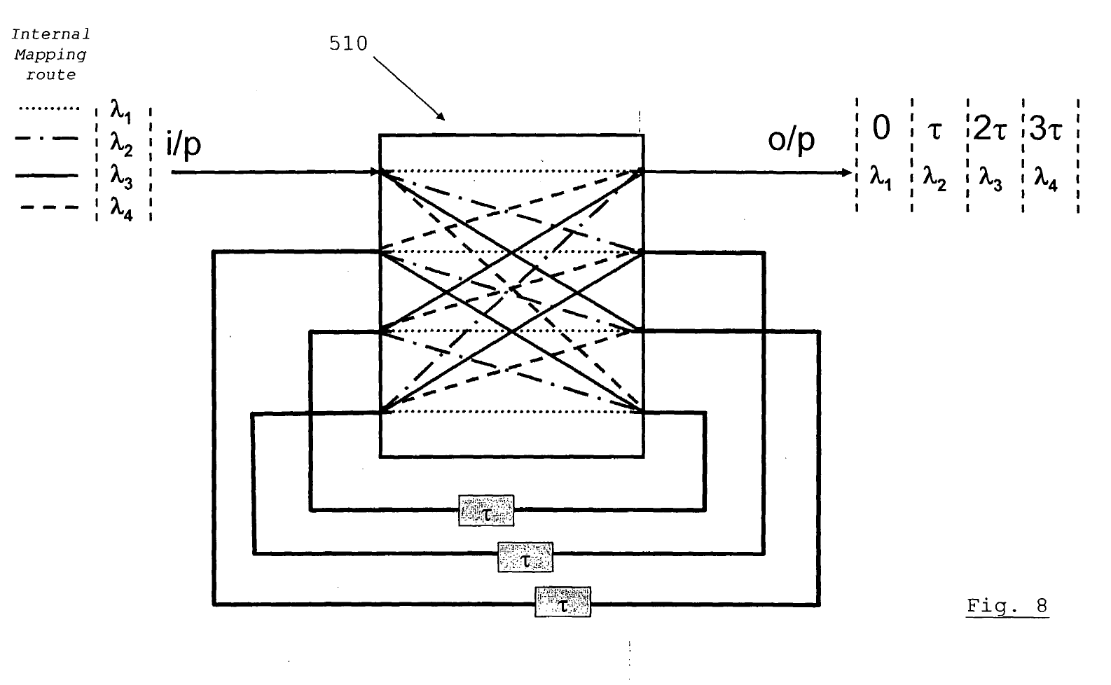

Such a perfectly dispersive device could find applications in a synthetic-aperture radar context. For example, if a WDM multiplexed signal is input into the 4×4 device 510 shown in FIG. 7, the wavelengths will emerge each delayed by a time in proportion to its wavelength, e.g. as indicated in FIG. 8. In FIG. 8, the dotted, dot-dashed, solid and dashed lines represent the internal mapping routes of four wavelengths λ₁, λ₂, λ₃ and λ₄ of increasing wavelength, which are delayed by 0, τ, 2τ and 3τ, respectively.

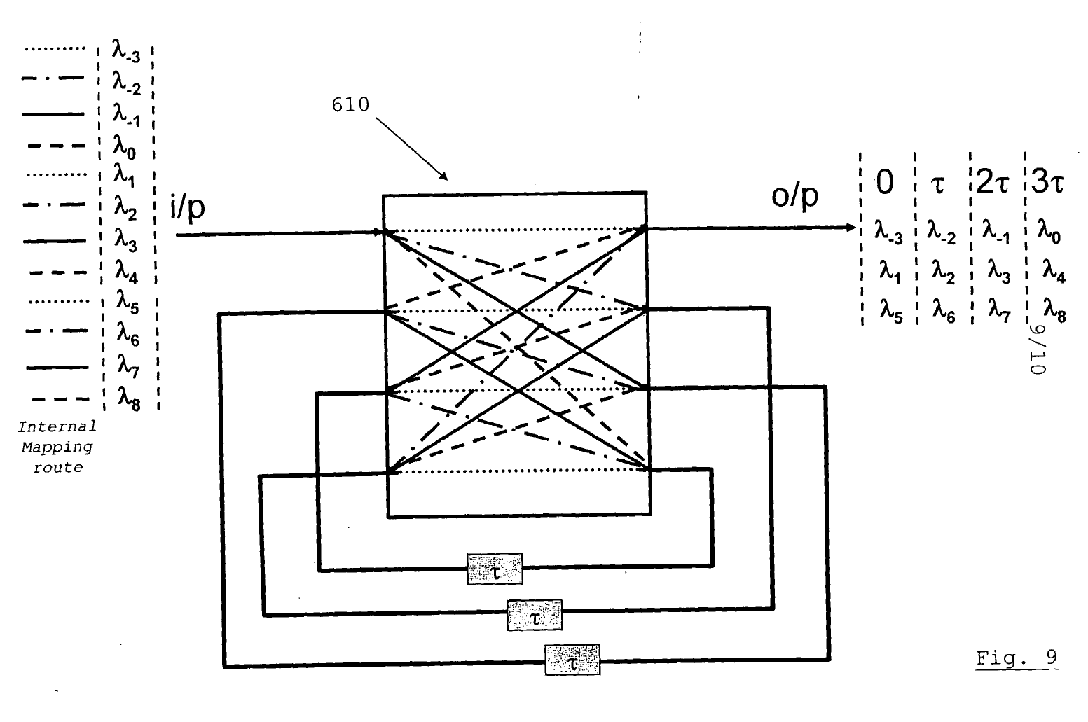

In addition, for an AWG designed such that its free-spectral range (FSR) is equal to N×Δλ (where Δλ is the wavelength spacing between adjacent WDM channels), sending a signal consisting of multiple WDM channels spanning more than one FSR will cause the WDM channels to be demultiplexed into one of N time slots, according to the relative position of each WDM channel in the FSR. An example device 610, for N=4 with 12 WDM channels spanning 3 FSR's, is shown in FIG. 9.

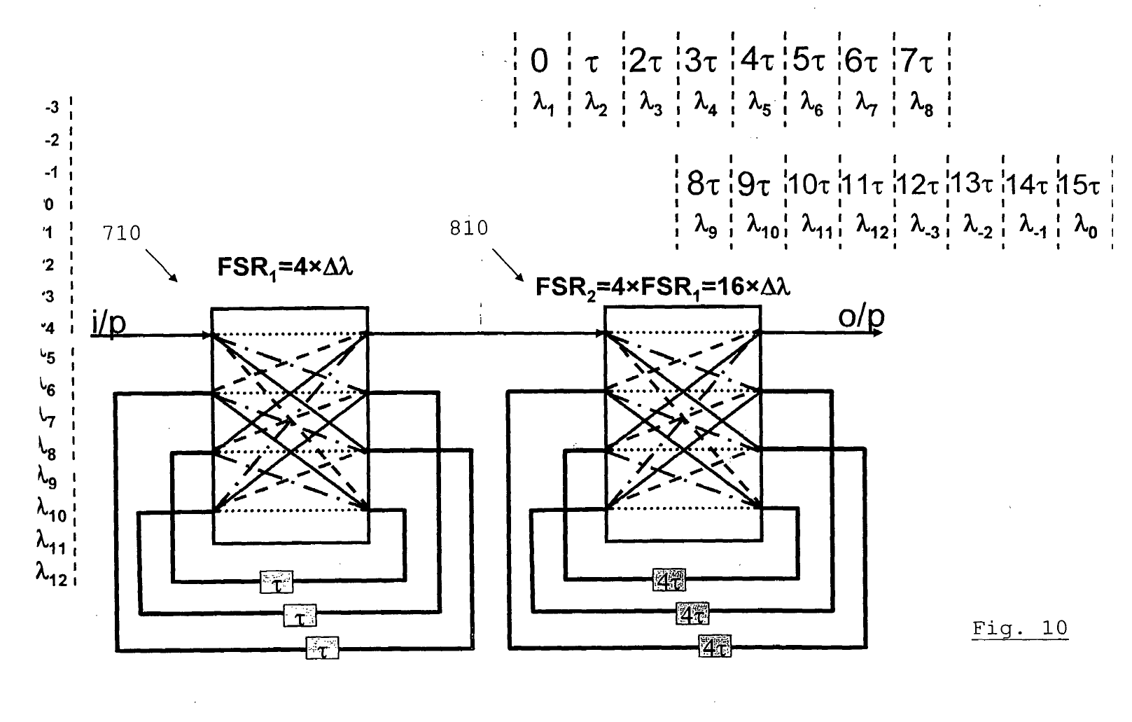

Perfect-dispersion devices can also be concatenated, as shown in FIG. 10. To achieve appropriate delays for all the wavelengths, it is necessary to increase the second device's FSR and also passband channel width by a factor N, as well as increasing the waveguide lengths (and hence delays) in the second device by a factor of N. That is as indicated in FIG. 10, which shows two cascaded 4×4 AWGs 710, 810, which can therefore achieve 16 different time delays. The FSR of the second device 810 is made equal to four times the FSR of the first device 710, with the passband of the second device 810 also made equal to four times the WDM channel spacing. The two cascaded 4×4 devices are functionally equivalent to a single 16×16 device.

It should be noted that the devices 510, 610, 710, 810 shown in FIGS. 7-10 are all passive in nature (i.e. the internal mappings are not actively changed) and rely on the natural dispersive (demultiplexing) nature of an AWG.

While the present invention has been described and illustrated with reference to particular embodiments, it will be appreciated by those of ordinary skill in the art that the invention lends itself to many different variations not specifically illustrated herein. For that reason, reference should be made to the claims for determining the true scope of the present invention.

What is claimed is:

1. A device for providing a delay to an optical signal, comprising:
a Latin router comprising a plurality of input ports, including at least one signal-input port, and a plurality of output ports, including at least one signal-output port, wherein input ports are mapped within the router to output ports according to a Latin-routing mapping matrix; and
a plurality of optical waveguides, each connecting one of the input ports to one of the output ports that is not a signal-output port,
wherein at least two of the plurality of waveguides are of the same length and wherein the plurality of waveguides are connected between the input ports and the output ports in an arrangement such that a first signal entering the device and mapped to any one of the output ports experiences a delay that is different from a delay that is experienced by a second signal entering the device and mapped to a different one of the output ports.

2. A device as claimed in claim 1, further comprising a tuning means that acts to alter the mapping between the input ports and the output ports.

3. A device as claimed in claim 1, in which only one input port is a signal-input port.

4. A device as claimed in claim 3, in which all input ports other than the signal-input port are connected to output ports by the waveguides.

5. A device as claimed in claim 1, in which there are a plurality of signal-input ports.

6. A device as claimed in claim 5, in which the waveguides connect output ports to at least some of the signal-input ports.

7. A device as claimed in claim 6, in which the waveguides are connected to the signal input ports at optical circulators.

8. A device as claimed in claim 5, in which at least one of the waveguides is connected to a nonlinear optical loop mirror.

9. A device as claimed in claim 1, in which the Latin router is one of an arrayed waveguide grating; a Mach-Zehnder interferometer; or a Micro-Electro-Mechanical System optical router.

10. A method of delaying an optical signal, comprising:
inputting an optical signal into a Latin router comprising a plurality of input ports, including at least one signal-input port, and a plurality of output ports, including at least one signal-output port;
delaying the signal by routing the signal within the router to an output port and guiding the signal from said output port to one of the input ports along one of a plurality of waveguides, at least two of which are of equal length, each of the plurality of waveguides being connected to one of the output ports and joining said output port to one of the input ports; and outputting the signal from the router.

11. A method as claimed in claim 10, further comprising tuning a tuning means associated with the router, to change the routing of the signal from the input port to the output port.

12. A method as claimed in claim 10, further comprising storing the signal within the router and waveguides.

13. A method as claimed in claim 10, wherein the input signal comprises a plurality of multiplexed channels, and the method comprises demultiplexing the channels, and routing the demultiplexed channels to a plurality of the output ports, guiding the channel or channels routed to each of said output ports to a respective one of the input ports along a respective one of a plurality of waveguides at least two of which are of the same length, and outputting the channel or channels from the router.

14. A method as claimed in claim 13, in which the channels are demultiplexed prior to entering the input port of the router.

15. A method as claimed in claim 14, in which the demultiplexed channels are input into the router on different input ports.

16. A method of simulating a device for delaying an optical signal according to claim 1, comprising:
(a) selecting a desired delay;
(b) simulating inputting an optical signal into the Latin router;
(c) simulating delaying the signal by:
( i) routing the signal within the router to an output port;
(ii) guiding the signal from said output port to one of the input ports along one of the plurality of waveguides, said plurality of waveguides being arranged in a first arrangement;
(iii) repeating steps (i) and (ii) until the signal arrives at the signal-output port; and
(iv) noting the total delay accumulated in steps (i) to (iii);
(d) simulating altering the delay experienced by the signal by altering at least one waveguide connection to provide a different arrangement of waveguides and by repeating step (c); and
(e) repeating step (d) to identify an arrangement of connections that provides the desired delay.

17. A method as claimed in claim 16, step (c) further comprising simulating altering the internal mapping of the router so that the signal is routed to a different output port and repeating steps (c) (i) to (iv).

18. A method as claimed in claim 16, further comprising repeating steps (b) to (d) until all permutations of waveguide arrangement and internal mapping have been simulated.

19. A method as claimed in claim 16, further comprising selecting a set of desired delays associated with each of the input ports, simulating input of a signal on each of the input ports and simulating connecting the plurality of waveguides to different input and output ports to identify an arrangement of connections that provides the desired set of delays.

20. A method as claimed in claim 19, wherein the selected set of delays is a set of delays for a plurality of multiplexed channels comprised in the signal, and the method comprises simulating passage of the channels through the device for different arrangements of connections and identifying an arrangement of connections that provides the desired set of delays.

21. A method as claimed in claim 19, wherein the router has N input ports and N output ports and a signal routed to the nth output port (where n is an integer between 1 and N, inclusive) is delayed by a delay of n−1 times a delay τ, for all n.

22. A method of delaying an optical signal, comprising constructing a device as claimed in claim 1 according to an arrangement identified by a method of claim 16.

23. A device as claimed in claim 1, wherein the plurality of waveguides are connected between the input ports and the output ports in an arrangement identified by a method according to claim 16.

24. An apparatus, comprising:
a Latin router comprising a plurality of input ports and a plurality of output ports, wherein input ports are mapped within the router to output ports according to a Latin-routing mapping matrix; and
a plurality of optical waveguides, each connecting one of the input ports to one of the output ports,
wherein the plurality of waveguides are connected between the input ports and the output ports in an arrangement such that a first signal entering the device and mapped to any one of the output ports experiences a delay that is different from a delay that is experienced by a second signal entering the device and mapped to a different one of the output ports.

25. The apparatus of claim 24, wherein the plurality of input ports includes at least one signal-input port, and the plurality of output ports includes at least one signal-output port.

26. The apparatus of claim 25, wherein at least two of the plurality of waveguides are of the same length.
